(19) United States
(12) Patent Application Publication
(10) Pub. No.: US 2016/0132760 A1
(43) Pub. Date: May 12, 2016

(54) DYNAMIC RECOGNIZABLE TWO-DIMENSIONAL CODE FOR INTERACTION BETWEEN ELECTRONIC DEVICES

(71) Applicant: Kuei-Sheng TSOU, Hsinchu (TW)

(72) Inventor: Kuei-Sheng TSOU, Hsinchu (TW)

(21) Appl. No.: 14/534,831

(22) Filed: Nov. 6, 2014

(51) Int. Cl. G06K 19/06; G06F 3/0484

(52) U.S. Cl. CPC G06K 19/06112; G06F 3/0484; G06K 19/06037; G06K 19/06103

(57) ABSTRACT

A dynamic recognizable 2D-code for interaction between electronic devices is provided, applicable to a displaying electronic device displaying the dynamic recognizable 2D-code and a capturing electronic device using a camera module to capture the dynamic recognizable 2D-code displayed by a display screen of the displaying electronic device; including at least a 2D-code, a recognizable image, and a displaying pattern; wherein the 2D-code being a representation of a plurality of data in 2D-code format; the recognizable image being recognizable by human eyes and touchable when displayed on a touch screen, the touching detected by an application and triggering subsequent operations defined by the application; and the displaying pattern defining a sequence of displayed images with each displayed image of specific displayed duration, each displayed image being one of the 2D-code or recognizable image, and the dynamic recognizable 2D-code can be displayed cyclically.

### TECHNICAL FIELD

The technical field generally relates to a dynamic recognizable two-dimensional (2D) code for interaction between electronic devices. The dynamic recognizable 2D-code is displayed on a display screen.

### BACKGROUND

Two-dimensional codes are widely used. Some of the common 2D-code includes Code 49, Code 16K, PDF417, SuperCode, Dot Code A, USS Code One, MaxiCode, Data Matrix, Aztec Code, QR Code, and so on.

The QR-code (Quick Response Code) is one of matrix barcodes which was originally designed for industrial applications, but has gained popularity in consumer market.

As the technology and application progress, additional features are continuously added to the QR-code, one of the added features is conventionally recognizable to human eyes and creates personalized style. For example, a recognizable QR-code is developed to include a static image that is recognizable to human eye to enhance the user convenience when selecting a QR-code to user. However, the basic function of the QR-code in commercial and advertising application remains the same, that is, to deliver special/assigned message to a capturing device or to link the capturing device to a specific website.

### SUMMARY

An exemplary embodiment describes a dynamic recognizable 2D-code for interaction between electronic devices, applicable to a displaying electronic device displaying the dynamic recognizable 2D-code and a capturing electronic device using a camera module to capture the dynamic recognizable 2D-code displayed by the displaying electronic device; the dynamic recognizable 2D-code including at least a 2D-code, a recognizable image, and a displaying pattern; wherein the 2D-code being a representation of a plurality of data in a 2D-code format, the plurality of data including information on establishing connection and interaction between the displaying electronic device and the capturing electronic device; the recognizable image being recognizable by human eyes, and the displaying pattern defining a sequence of displayed images with each displayed image of specific displayed duration, each displayed image being one of the 2D-code or recognizable image, and the dynamic recognizable 2D-code can be displayed cyclically.

The plurality of data may vary depending on the application and the interaction between the electronic devices. In an embodiment, for example, the data may include at least a device data to identify the displaying electronic device, an information exchange protocol to indicate the interaction between two electronic devices conducted through the dynamic recognizable 2D-code, and a validation key for pairing and matching between two electronic devices conducting the interaction.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a 2D-code and a recognizable image of a dynamic recognizable 2D-code accordance with an exemplary embodiment; and

FIG. 2 shows a schematic view of a dynamic recognizable 2D-code displayed in exemplary displaying pattern.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the following embodiment, a QR-code is used as an exemplary 2D-code to describe the structure and the use of the present invention. However, it is noted that the technical feature of the present invention is also applicable to other types of 2D-codes.

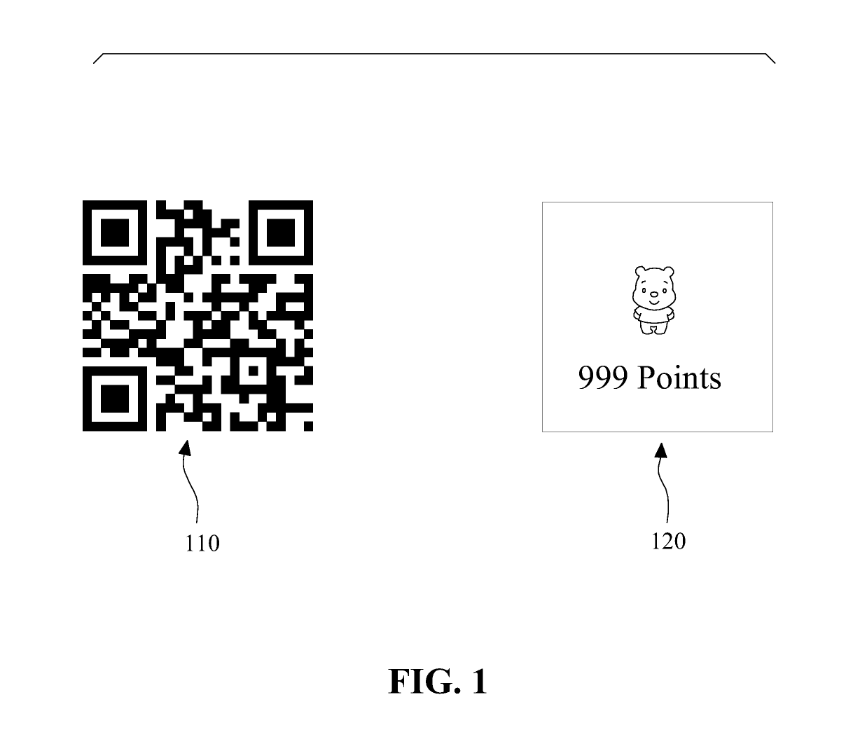

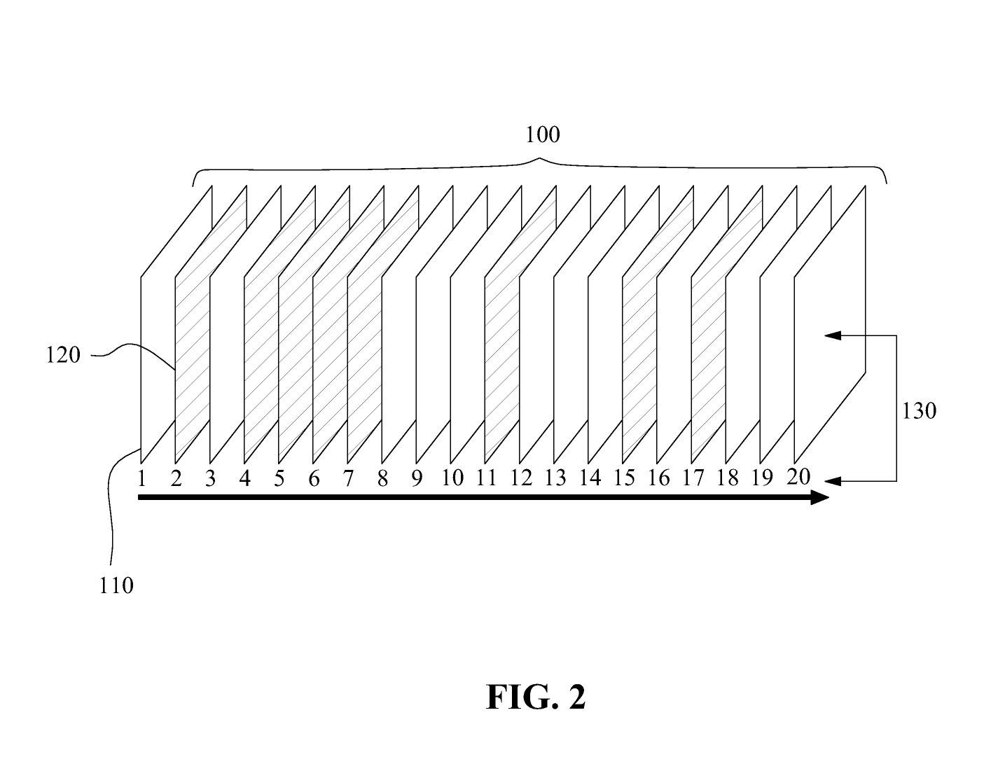

FIG. 1 shows a schematic view of a 2D-code and a recognizable image of a dynamic recognizable 2D-code accordance with an exemplary embodiment; and FIG. 2 shows a schematic view of a dynamic recognizable 2D-code displayed in exemplary displaying pattern. As shown in FIG. 1 and FIG. 2, a dynamic recognizable 2D-code 100 for interaction between electronic devices, applicable to a displaying electronic device displaying the dynamic recognizable 2D-code 100 and a capturing electronic device using a camera module to capture the dynamic recognizable 2D-code 100 displayed by a display screen of the displaying electronic device; the dynamic recognizable 2D-code 100 including at least a 2D-code 110, a recognizable image 120, and a displaying pattern 130 with a displaying period T; wherein the 2D-code 110 being a representation of a plurality of data in a 2D-code format; and the displaying pattern 130 defining a sequence of displayed images, each displayed image being a 2D-code 110 or a recognizable image 120, and the dynamic recognizable 2D-code 100 being displayed cyclically. In this exemplar, the displaying pattern 130 includes 12 2D-codes 110 and 8 recognizable images 120, with each displayed image of specific displayed duration one-twentieth of displaying period T.

It should be noted that when a user touches a recognizable image 120 of a dynamic recognizable 2D-code 100 displayed on a touch display screen, the touching can be detected by an application program of displaying electronic device monitoring the touch display screen. Therefore, a user touching the dynamic recognizable 2D-code 100 can be detected by the application program and triggers subsequent operations defined by the application program.

In addition, the recognizable image 120 may also be a recognizable figure overlaying on a 2D-code, a blank image, and a transparent page.

It should also be noted that the plurality of data encoded in the 2D-code includes information on how to establish connection and interaction between the displaying electronic device and the capturing electronic device. The plurality of data includes at least a device data to identify the displaying electronic device, an information exchange protocol to indicate the interaction between two electronic devices conducted through the dynamic recognizable 2D-code, and a validation key for pairing and matching between two electronic devices conducting the interaction.

In addition, it should also be noted that in the displaying pattern, each of the 2D-code and the recognizable image may be different.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A dynamic recognizable two-dimensional (2D) code for interaction between electronic devices, applicable to a displaying electronic device displaying the dynamic recognizable 2D-code and a capturing electronic device using a camera module to capture the dynamic recognizable 2D-code displayed by a display screen of the displaying electronic device; the dynamic recognizable 2D-code comprising:
at least a 2D-code, a recognizable image, and a displaying pattern;
wherein the 2D-code being a representation of a plurality of data in a 2D-code format;
the recognizable image being recognizable by human eyes; and
the displaying pattern defining a sequence of displayed images with each displayed image of specific displayed duration, each displayed image being one of the 2D-code or recognizable image.

2. The dynamic recognizable 2D-code as claimed in claim 1, wherein the user touching a recognizable image displayed on a touch display screen may be detected by an application and triggers subsequent operations defined by the application.

3. The dynamic recognizable 2D-code as claimed in claim 1, wherein each of the 2D-code and the recognizable image may be different in the displaying pattern.

4. The dynamic recognizable 2D-code as claimed in claim 1, wherein the recognizable image further comprises a recognizable figure overlaying a 2D-code, a blank image, and a transparent page.
